(19) United States
(12) Patent Application Publication
(10) Pub. No.: US 2006/0265821 A1
(43) Pub. Date: Nov. 30, 2006

(54) Vibrating paint applicator

(76) Inventor: Michael Hause, Akron, OH (US)

Correspondence Address: LITMAN LAW OFFICES, LTD, PO BOX 15035, CRYSTAL CITY STATION, ARLINGTON, VA, 22215, US

(21) Appl. No.: 11/431,024

(22) Filed: May 10, 2006

Related U.S. Application Data
(60) Provisional application No. 60/683,794, filed on May 24, 2005.

(51) Int. Cl. A46B 13/02; B05C 17/02

(52) U.S. Cl. 15/22.1; 15/103.5

(57) ABSTRACT

The vibrating paint applicator includes a removable or permanently installed vibration-producing device, which produces a low amplitude vibration to break the capillary action of the bristles or nap in a brush or roller to cause the paint to flow more readily therefrom. The vibrator may be permanently installed within the handle or body of the applicator, or may be removably attachable thereto. A small motor and small eccentric weight may be used, or other principles may be used, e.g., an oscillator circuit driving a weighted solenoid, etc. The device may be powered by batteries or other portable power supply in order to avoid the need for electrical cords, remote power supplies, and/or use of high voltage power from the electrical grid.

### CROSS-REFERENCE TO RELATED APPLICATION

This application claims the benefit of U.S. Provisional Patent Application Ser. No. 60/683,794, filed May 24, 2005.

### BACKGROUND OF THE INVENTION

1. Field of the Invention

The present invention relates generally to tools and implements for applying paint and similar coatings to various surfaces. More particularly, the present invention comprises various embodiments of a vibrating mechanism in combination with a paintbrush, roller, or similar paint applicator.

2. Description of the Related Art

Brushes, rollers, pads, and perhaps other applicators for applying paint or similar material to a surface, have been known for a considerable period of time. More recently, various powered systems have been developed for the application of paint or similar coating materials. These systems generally use pneumatic pressure to spray a relatively thin material from the spray gun onto the surface. Other systems have been developed wherein paint is forced or drawn through a hose or tube to a roller or other applicator to flow from the applicator onto the surface being painted. None of these devices utilize any form of vibration for applying the paint or coating material.

However, the present inventor is aware of some devices that use a vibration principle for the application of a liquid material to a surface. One such device is disclosed in German Patent No. 19,705,208 published on Sep. 24, 1998, which appears to describe (according to the drawings; no English translation available) a vibrating drive system for a brush. The brush has two parts, a handgrip and a bristle portion joined by a plug and socket, the handgrip housing a motor powered from an AC outlet that imparts a vibratory or swinging motion across the direction of travel of the bristles in order to eliminate stripes or cross-streaks in the application of dyes, stains or other coatings, possibly including paint.

However, there is still a need for a device to improve the even application of pain to a surface. Thus, a vibrating paint applicator solving the aforementioned problems is desired.

### SUMMARY OF THE INVENTION

The vibrating paint applicator produces a low amplitude oscillating vibration of the bristles of a brush or nap of a roller in order to shake paint captured between the bristles or within the nap, thereby causing the paint to flow more completely from the brush, roller, or other paint applicator.

The device producing the vibration of the paint applicator may be permanently installed within the body or handle of the applicator, or may be a detachable device that may be applied to different brushes, rollers, or other applicators as desired. A relatively small electric motor is used to drive a small eccentric weight, thereby producing a rapid, low amplitude vibration or oscillation which serves to break the capillary action, causing the paint to wick up into the bristles of the brush or nap of the roller or pad, and to flow smoothly and freely from the bristles or nap for application to the surface being painted.

The vibratory axis may be oriented parallel or normal to the bristles or nap surface of the applicator, as desired. Other devices for inducing vibratory motion may be substituted for the rotary motor shaft with the eccentric weight as desired, e.g., an oscillator circuit driving a weighted solenoid, a motor with a reciprocating linkage, etc. The applicator is preferably electrically powered by self-contained battery pack in order to preclude separate, remote power supplies, electrical cords, and/or relatively high voltage systems using electrical grid power.

These and other features of the present invention will become readily apparent upon further review of the following specification and drawings.

### BRIEF DESCRIPTION OF THE DRAWINGS

FIG. 1 is a partially broken away perspective view of a vibrating paint applicator according to the present invention, illustrating the internal mechanism thereof.

FIG. 2 is an exploded perspective view of an alternative embodiment of a vibrating paint applicator according to the present invention having a removable vibrator unit attached to a brush.

FIG. 3 is a partially broken away perspective view of another alternative embodiment of a vibrating paint applicator according to the present invention, wherein the mechanism is permanently installed within the handle of the brush.

FIG. 4 is an exploded perspective view of yet another alternative embodiment of a vibrating paint applicator according to the present invention having a removable vibrator unit for attachment to a paint roller handle.

Similar reference characters denote corresponding features consistently throughout the attached drawings.

### DETAILED DESCRIPTION OF THE PREFERRED EMBODIMENTS

The present invention comprises several embodiments of a vibrating paint applicator (e.g., brush, roller, etc.). The applicator combines an electrically powered vibrator with a paint applicator, the vibrator breaking the capillary action of the bristles or nap of the brush or roller to allow the paint to flow more freely therefrom. The vibrator comprises a small device, which may have a self-contained power source in order to preclude power cords and relatively high voltage systems.

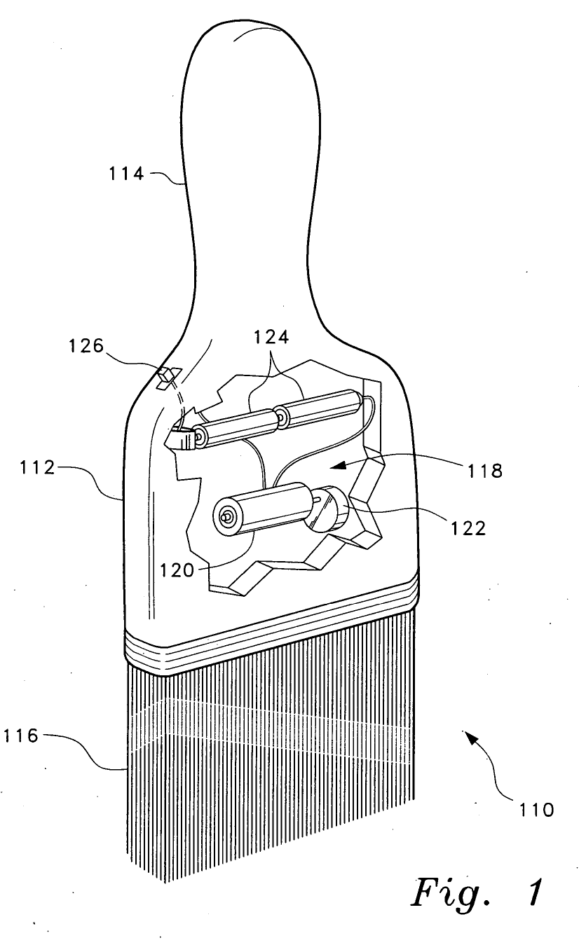

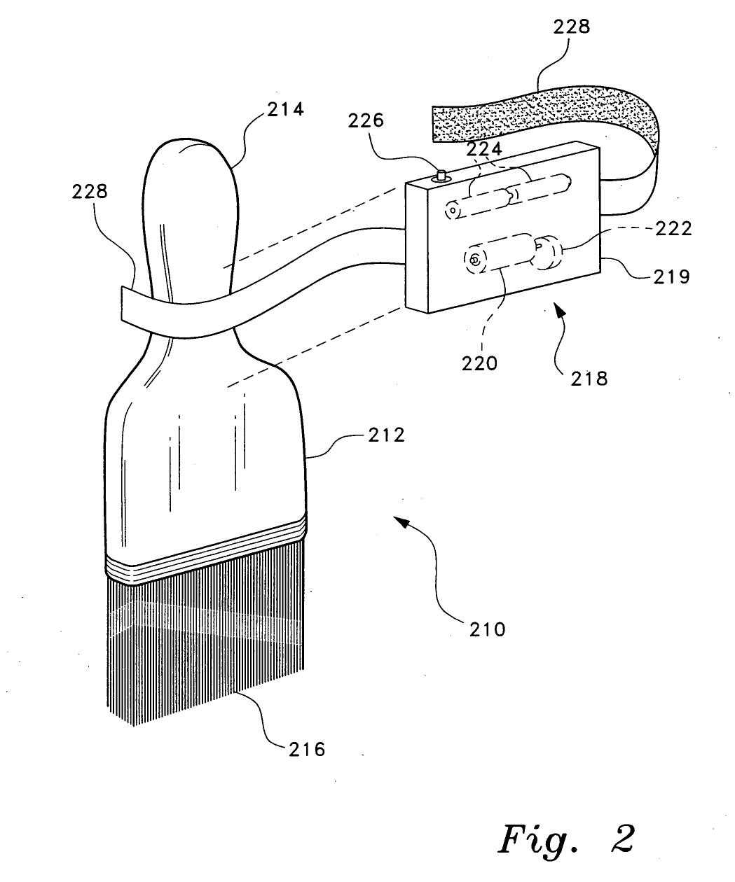

FIG. 1 of the drawings illustrates a first embodiment of the present invention, wherein a paintbrush 110 includes an integral, permanently installed vibrator system therein. The paintbrush 110 includes a body 112 with a handle 114 extending therefrom, and a plurality of generally parallel paintbrush bristles 116 extending from the body portion 112 generally opposite the handle 114. A vibrator assembly 118 is disposed permanently within the body 112 of the brush 110 and provides the vibration required to work the paint from the bristles 116. Alternatively, the vibrator assembly could be provided in the form of a cartridge, e.g., the housing 219 of the embodiment of FIG. 2, and removably installed within a pocket or cavity in the body 112 of the brush 110, if so desired.

The vibrator assembly 118 may comprise a small electric motor 120 with an eccentric weight 122 extending from the output shaft thereof. Other types of vibrators may be used, e.g., a conventional oscillator circuit which drives a weighted solenoid to rapidly open and close the solenoid to drive its weight rapidly back and forth, a motor attached to a reciprocating linkage that tamps the walls of the cavity defined in the body 112, a mechanical device having sufficient mass in its moving components to provide the required vibration, etc. It will be noted that while the output shaft of the motor 120 is parallel to the span of the brush 110, thus oscillating the brush body 112 and bristles 116 both axially and across the thickness of the brush body 112, other orientations for the motor and its eccentric weight or other vibrating mechanism may be used as desired to change the orientation of the oscillations.

One or more rechargeable or replaceable electrical storage cells or batteries 124 may be used to provide power for the motor 120 to preclude the need for an external cord and a high voltage power supply. An electrical switch, e.g., the slide switch 126 illustrated in FIG. 1, or other switch type, e.g., pushbutton, rocker, toggle, etc., is used to turn the circuit on and off to actuate and deactivate the motor 120 and its eccentric weight 122. When the switch 126 is closed, the vibrations from the eccentric weight 122 produce a series of relatively low amplitude, high frequency vibrations (depending upon the rpm of the motor 120) to work any paint captured by the bristles 116 from the bristles and onto the surface being painted or coated.

FIG. 2 illustrates an alternative embodiment, in which the vibrator assembly 218 is a separate unit removably secured to a conventional paintbrush 210. The vibrator assembly may be contained within a separate case or housing 219 and contains a small electric motor 220 driving a small eccentric weight 222. The motor 220 is powered by electrical cells or batteries 224, essentially as the embodiment illustrated for the brush 10 of FIG. 1. An electrical switch, e.g., normally open, momentary contact pushbutton switch 226, is used to actuate and deactivate the vibrator assembly 218. The slide switch used for the brush 110 assembly of FIG. 1, or other types of switches, may be used in lieu of pushbutton switch 226, but a normally open switch requires the user to maintain pressure upon the switch during operation, thereby precluding inadvertent operation of the device.

The housing 219 may be secured removably to the body 212 or handle 214 of the brush 210 by means of mating hook and loop fabric material (e.g., Velcro®) straps 228, or other fastening means, as practicable. It will be noted that the orientation of the vibration axes is dependent upon the orientation of the case or housing 219 when attached to the brush 210. The straps 228 or other attachment means may be oriented to position the motor shaft parallel to the span of the brush 216, as in the orientation of the device in FIG. 1, or in some other orientation to produce vibration in a different plane(s) relative to the orientation of the brush bristles 216, as desired.

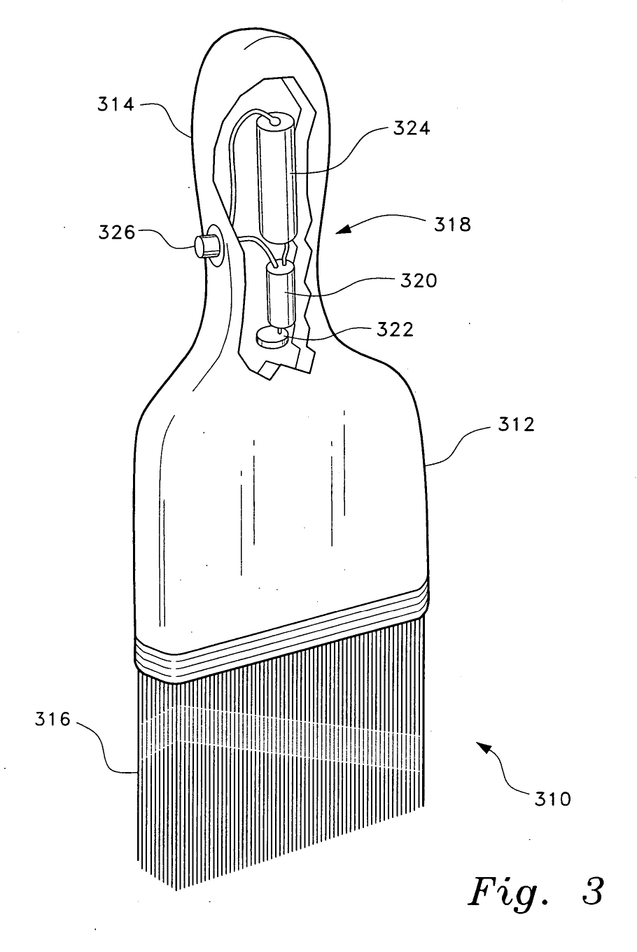

FIG. 3 of the drawings illustrates yet another embodiment, designated as paintbrush 310. The brush 310 is similar to the brush 110 of the embodiment of FIG. 1, having a body 312 with a handle 314 extending therefrom and a brush or bristle assembly 316 extending from the body 312 generally opposite the handle 314. However, rather than placing the vibrator assembly 318 within the body of the brush, as in the case of the embodiment of FIG. 1, the brush 310 has a permanently installed vibrator assembly 318 disposed within the handle 314. The relative length of the motor 320 and battery 324 facilitates the orientation of the assembly 318 within the length of the handle 314, thus resulting in the eccentric weight 322 producing vibration in planes normal to the length of the brush bristles 316. A switch, e.g., normally open pushbutton switch 326 or other switch type, may be disposed on the handle 324 or other convenient location, as desired.

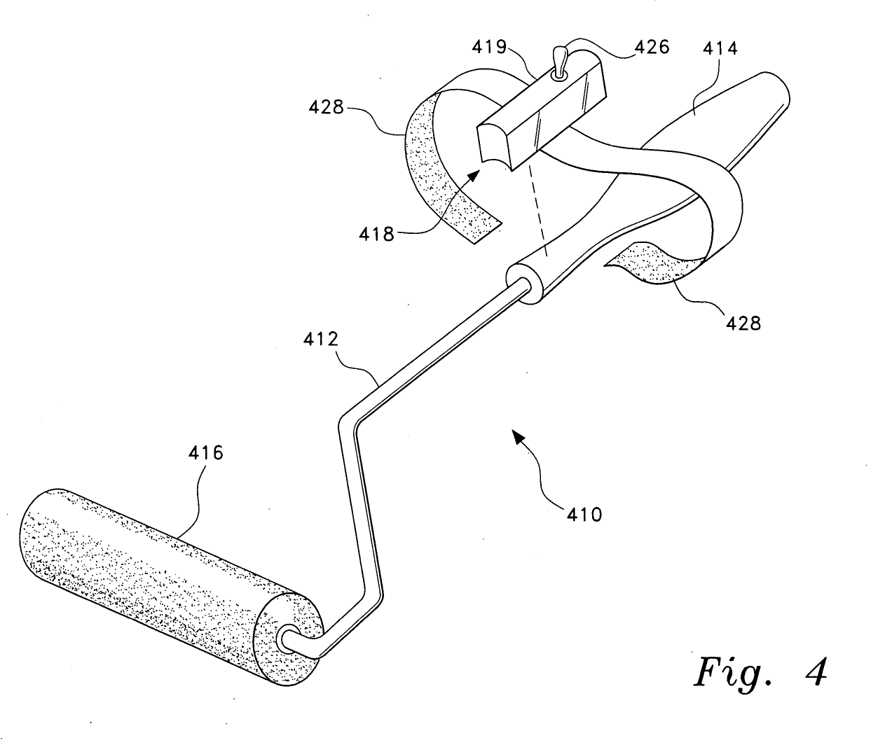

FIG. 4 illustrates still another embodiment of the present vibrating paint applicator, wherein a vibrator assembly is installed upon a paint roller 410, or more specifically is removably secured to the handle 414 thereof. The roller 410 includes a body or frame 412 with the handle 414 extending therefrom, and the paint-dispensing roller 416 disposed generally opposite the handle 414. The vibrator assembly 418 is contained within a case or housing 419, and contains a motor, battery or other portable power source, and eccentric weight, as in the embodiments of FIGS. 1 through 3. Alternatively, other vibration means may be used, e.g., the oscillator and solenoid system described further above, or other means as desired. A switch, e.g., a normally open or open/closed toggle switch 426 as shown in FIG. 4, or other switch type (slide, momentary contact pushbutton, rocker, etc.) may be used as desired. Temporary attachment means, e.g. mating hook and loop straps 428 or other means, may be used to secure the vibrating assembly 418 temporarily to the roller handle 414 as desired. Alternatively, the handle 414 may be hollow, and the vibrator assembly may be installed permanently therein, as in the case of the brush embodiment 310 of FIG. 3, or the vibrator device may be placed removably within a recess within the roller handle 414, as desired.

In conclusion, the vibrating paint applicator greatly facilitates the smooth and even application of paint or similar liquid coating material to various surfaces. The present device is particularly well suited for use with paintbrushes, either as a permanently installed component or as a detachable and removable component. However, it is also suited for adoption for use with a paint roller or even a paint pad, if so desired. When used with a paint brush, the vibrating or oscillating effect causes the paint or other coating (stain, etc.) to flow from the bristles more effectively, thus providing more rapid and more effective coverage per each brush stroke. This vibration of the bristles also better urges the bristles into minute porosities, cracks, and the like, to provide a higher quality finish of such areas. Much the same is true of the nap of a roller equipped with the present vibrator device, as well.

When cleaning a vibrating brush or roller, the relatively small amplitude vibrations enhance the flushing of paint or other material from the brush with water or other solvent, as required. This provides for more rapid cleanup after painting, and also improves the quality of the cleanup job to prolong the life of the brush or roller. Another benefit of the present device is that is also massages and stimulates blood flow to the hand of a person using a brush or roller so equipped, thus reducing cramping and other negative effects caused by long hours of holding a brush or roller handle. Thus, the present vibrating or oscillating paint applicator in its various embodiments will be greatly appreciated by both amateur and professional painters alike.

It is to be understood that the present invention is not limited to the embodiments described above, but encompasses any and all embodiments within the scope of the following claims.

I claim:

1. A vibrating paint applicator, comprising:
an applicator having:
a body;
a handle extending from the body; and
a paint dispensing component extending from the body opposite the handle;
an electrically powered vibrator coupled to the applicator; and
a portable electrical power supply electrically connected to the vibrator.

2. The vibrating paint applicator according to claim 1, wherein said vibrator is permanently installed within said body.

3. The vibrating paint applicator according to claim 1, wherein said vibrator is permanently installed within said handle.

4. The vibrating paint applicator according to claim 1, wherein said vibrator is removably secured external to said body.

5. The vibrating paint applicator according to claim 1, wherein said vibrator is removably secured external to said handle.

6. The vibrating paint applicator according to claim 1, wherein said vibrator is selected from the group consisting of electric motors driving eccentric weights and oscillator circuits driving weighted solenoids.

7. The vibrating paint applicator according to claim 1, further including a switch selected from the group consisting of normally open momentary contact switches, slide switches, toggle switches, and rocker switches.

8. The vibrating paint applicator according to claim 1, wherein said paint dispensing component is a paint brush.

9. The vibrating paint applicator according to claim 1, wherein said paint dispensing component is a paint roller.

10. A vibrating paint brush, comprising:
an applicator having:
a body;
a handle extending from the body; and
a plurality of paint bristles extending from said body opposite said handle;
an electrically powered vibrator coupled to the applicator; and
a portable electrical power supply electrically connected to the vibrator.

11. The vibrating paint brush according to claim 10, wherein said vibrator is permanently installed within said body.

12. The vibrating paint brush according to claim 10, wherein said vibrator is permanently installed within said handle.

13. The vibrating paint brush according to claim 10, wherein said vibrator is removably secured external to said body.

14. The vibrating paint brush according to claim 10, wherein said vibrator is removably secured external to said handle.

15. The vibrating paint brush according to claim 10, wherein said vibrator is selected from the group consisting of electric motors driving eccentric weights and oscillator circuits driving weighted solenoids.

16. The vibrating paint brush according to claim 10, further including a switch selected from the group consisting of normally open momentary contact switches, slide switches, toggle switches, and rocker switches.

17. A vibrating paint roller, comprising:
a roller body;
a handle extending from the roller body;
a paint dispensing roller disposed upon the roller body opposite the handle;
an electrically powered vibrator removably secured to the handle; and
a portable electrical power supply electrically connected to the vibrator.

18. The vibrating paint roller according to claim 17, wherein said vibrator is selected from the group consisting of electric motors driving eccentric weights and oscillator circuits driving weighted solenoids.

19. The vibrating paint roller according to claim 17, further including a switch selected from the group consisting of normally open momentary contact switches, slide switches, toggle switches, and rocker switches.
